(19) United States
(12) Patent Application Publication
(10) Pub. No.: US 2012/0193342 A1
(43) Pub. Date: Aug. 2, 2012

(54) ELECTRICALLY HEATABLE SOCK, SOCK HEATING ARRANGEMENT AND ALSO METHOD FOR PRODUCING AN ELECTRICALLY HEATABLE SOCK

(75) Inventors: DAVID MACHER, Voitsberg (AT); Gerhard Kremer, Fuerstenfeld (AT); Urs Maron, Nidau (CH)

(73) Assignees: LENZ GMBH, Schwarzach (AT); THERM-IC PRODUCTS GMBH NFG. & CO. KG, Gleisdorf (AT)

(21) Appl. No.: 13/352,397

(22) Filed: Jan. 18, 2012

(30) Foreign Application Priority Data
Feb. 1, 2011 (EP) 11075018.9

(51) Int. Cl. H05B 3/00; B23P 19/04

(52) U.S. Cl. 219/211; 29/428

(57) ABSTRACT

The invention relates to an electrically heatable sock having a foot part and a leg part abutting thereon, at least one heating element being disposed on the foot part which is connected via supply lines to terminals for a voltage supply which has a battery, the terminals being disposed in the upper region of the leg part. As a result of the fact that a cuff which can be folded over is disposed on the upper end of the leg part, the terminals being attached and formed on the side of the cuff situated inside in the folded-over state in order to fix the battery in the correct position in the folded-over state of the cuff and to retain it at least partially, a sock is made possible which is simple to produce and comfortable to wear and ensures a reliable attachment of the components necessary for heating.

### BACKGROUND OF THE INVENTION

The invention relates to an electrically heatable sock having a foot part and a leg part abutting thereon, at least one heating element being disposed on the foot part and being connected via supply lines to terminals for a voltage supply which has a battery, the terminals being disposed in the upper region of the leg part. Furthermore, the invention relates to a sock heating arrangement having an electrically heatable sock and a battery and also to a method for producing an electrically heatable sock.

Such socks, as are known for example from the publication DE 16 15 176, generally have a relatively complicated attachment of the battery to the sock. In addition, a pocket is required inside the sock for arrangement of the heating element, which pocket is complex to produce, on the one hand, and, on the other hand, leads to a considerable regional increase in material thickness in the sock, which might be perceived by the user as being detrimental to the wearing comfort.

It is therefore the object of the invention to produce an electrically heatable sock and a sock heating arrangement which are simple to produce, comfortable to wear and ensure a reliable attachment of the components necessary for heating.

### SUMMARY OF THE INVENTION

This object is achieved according to the invention by an electrically heatable sock having the features of claim 1, a sock heating arrangement having the features of claim 11 and a method having the features of claim 14. Advantageous developments and embodiments are revealed in the features of the sub-claims.

As a result of the design with a cuff which can be folded over and the corresponding arrangement and design of the contacts, the battery can be attached securely due to the folded-over cuff and can be placed in a position which is not uncomfortable for the user and preferably is not visible from outside. As a result of the fact that the terminals themselves are designed for correct positional fixing and at least partial retention of the battery, merely a flat construction is provided and the user is not inconvenienced when wearing the sock, in addition a reliable attachment of the necessary components being ensured.

According to the embodiment, the sock can be formed from one or a plurality of material layers.

In the case of two- or multilayer socks, foot- and leg parts have in addition to the cuff an inner sock and an outer sock which abut against the cuff in the direction towards the foot. As a result, a protected arrangement of the heating element with low production complexity of the sock is possible. Inner and outer sock both merge into the cuff in the upper region of the leg part.

However, also single-layer socks are possible. In the case of these, the heating element is generally applied on the inside of the sock. Seams which serve for attachment of the heating element can be visible from outside and serve as a design element. As an alternative to an attachment on the inside, also an attachment of the heating element on the outside of the sock is however possible. Single-layer socks have advantages in particular with respect to manufacturing complexity.

For particular preference, the terminals and the cuff are designed such that it becomes possible to retain the battery exclusively by means of the terminals and also by contact pressure via the folded-over cuff. Hence a simple and wearer-friendly arrangement of the battery is provided.

Preferably, the terminals are designed as contacts which constitute a form-fit and/or frictional connection. A particularly reliable mechanical connection of the battery is possible by designing the terminals as push-button contacts. Due to the design of contacts which constitutes a form-fit and/or frictional connection, simple separation of a battery or of a battery pack attached to the sock is possible. As a result, the complexity of changing the battery or disconnecting the battery for the purpose of charging is particularly low. Also disconnection of the battery for washing the sock is thus simplified.

In a further advantageous embodiment, the supply lines are disposed in a carrier element which is flexible at least in one, preferably in all, directions and are configured to extend preferably in a meandering, zigzag and/or undulating shape from a longitudinal direction of the sock. The carrier element preferably extends only over a partial region of the sock and is provided in addition to the material layer or layers of the sock. By means of the flexible, preferably stretchable and particularly preferably textile carrier element, particularly high wearing comfort for the electrically heatable sock is achieved. The meandering, zigzag or undulating design of the supply lines avoids a restriction in flexibility and/or stretchability of the carrier element due to the supply lines since stretching of the supply lines in the longitudinal direction of the sock leads only to a slight increase in the length of the strip conductor of the supply lines. The supply lines are therefore stretchable according to the principle of a spring. The heating element itself can be applied preferably jointly on the flexible carrier element. The heating element and the supply lines are then connected to each other in the region of the flexible carrier element.

For particular preference, a reinforcing element on which the connection is disposed can be applied on the flexible carrier element in the region of the connection between heating element and supply lines. As a result, the position of the lines which is more susceptible to mechanical damage, namely the connection, is protected additionally. The reinforcing element is preferably likewise flexible, a flexibility of the reinforcing element being particularly preferably less than the flexibility of the flexible carrier element.

Furthermore, an embedding material for enclosing the connection and also a textile covering the connection can be disposed on the reinforcing element. The covering textile and/or the reinforcing element can be saturated at least partially with the embedding material. In total, a laminate is thus formed by means of which optimal protection of the connection is achieved.

The terminals can be disposed on a preferably rigid and/or textile carrier which is attached to the cuff. By means of such a carrier, the heatable sock has sufficient strength in the region of the terminals to avoid the terminals slipping away during connection to an energy source or to a battery. When designed as a textile carrier, particularly simple application, for example by sewing on, is possible on the likewise textile material of the cuff during production of the sock.

In a further preferred embodiment, a tab which protrudes beyond one end of the cuff is fitted on the cuff. In the folded-over state, the tab hence protrudes beyond the end of the cuff in the direction towards the foot. By means of the tab, the cuff can be folded back in a simple manner from a folded-over state into an extended state so that an energy source connected to the sock at the terminals can be made accessible in a simple manner.

In a particularly preferred embodiment, the tab is designed in one piece with the carrier for the terminals. As a result, such a tab can be produced jointly without any additional complexity in the design of the carrier for the terminals.

Particular ease of use is achieved if at least one marking for a control element for controlling the heating power is disposed on an inner side of the cuff. After the cuff is folded over, the marking hence becomes visible for a user on the outside and can simplify operation of control elements which are fitted on the energy source folded into the cuff. As a result, the advantages of an arrangement of the energy source under the folded-over cuff, namely the arrangement which is secured in addition against slipping as a result of the cuff, protected from mechanical influences and, at the same time, not visible, can be combined with ease of use.

Preferably, the sock has a protector for the Achilles tendon, which protector can be integrated either in the inner sock, in the outer sock or between the inner and outer sock. The Achilles tendon protector can be formed for example by additional padding, greater material thickness and/or additional textile layers. By means of such an Achilles tendon protector, the risk of injury when practising a winter sport, for example when skiing, can be significantly reduced. The supply lines can extend preferably through this Achilles tendon protector. As a result, an arrangement of the supply lines which is imperceptible for a user of the sock is achieved, since the strength of the sock in this region is increased anyway by the Achilles tendon protector.

Furthermore, preferably inner and outer sock are connected to each other at at least two places. As a result, twisting of the inner sock relative to the outer sock is reliably avoided. Particularly high reliability is hereby produced if one of the connection places is disposed on the leg part and one connection place on the foot part. For example, inner and outer sock can be connected on or directly below the cuff and also in the toe region.

In a further advantageous embodiment of a two- or multilayer sock, the at least one heating element and/or the carrier element is disposed with supply lines between inner and outer sock. As a result, high mechanical protection of the heating element or of the supply lines is achieved, as a result of which the anticipated lifespan of the sock can be increased.

In the case of a single-layer sock, the carrier element with the heating element applied thereon and the supply lines are applied preferably on the inside of the sock. The heating element and the supply lines are thereby applied preferably on the side of the carrier element which points towards the sock, i.e. pointing away from the foot. As a result, the heating element is disposed, on the one hand, because of its arrangement on the inside of the sock, in a mechanically protected manner, whilst, on the other hand, direct contact of the skin with the heating element when wearing the sock is avoided on the basis of the carrier element pointing inwards. When wearing the sock, the inwardly pointing carrier element abuts on the foot or on the leg.

If the carrier element with the supply lines and the heating element is fitted on the outside of the sock, the supply lines and the heating element are disposed on the side of the carrier element which points towards the foot. Hence, even in an arrangement of the carrier element on the outside of the sock, mechanical protection of the heating element is ensured. The carrier element in an arrangement on the outside of the sock is visible and can serve as a design element.

Application of the heating element or of the carrier with supply lines is particularly simple by means of sewing. In order to achieve as good thermal contact with the foot as possible, the heating element or the carrier with the supply lines is sewn preferably onto the inner sock.

In addition to an electrically heatable sock, the invention relates to a sock heating arrangement having a heatable sock, as described previously, and a battery pack. The battery pack has contacts which correspond to the terminals of the sock, the battery pack being attached detachably to the sock via the contacts. By folding over the cuff after connection of the contacts to the terminals of the sock, the battery pack can be disposed invisibly and protected from mechanical stress below the cuff. The battery pack can consist of a housing element and a cover element, the housing element preferably having an undercut which serves for the purpose of enabling as large an interior of the housing element as possible for electronic components of the battery pack.

In a preferred embodiment of a sock heating arrangement, the battery pack includes a control unit for controlling the heating power, the control unit having a receiver for actuation via a remote control and/or an input element for setting a desired heating temperature. The input element is preferably disposed on the same side as the contacts and preferably is positioned such that, in the folded-over state of the cuff, the region of the cuff with the markings covers the at least one input element.

In addition, the invention relates to a method for producing a heatable sock, firstly a foot inner part, a leg inner part, a cuff, a leg outer part and a foot outer part being produced in the indicated sequence, for example knitted. Production in the precisely the reverse sequence is also possible.

In total, a tubular object which has at least one open end is thus produced. The ends of the tubular object are hereby formed by the foot inner part and the foot outer part, an opening of the tubular object being produced from a not yet manufactured toe region. There is hereby intended by a “tubular object”, not necessarily a simple small tube. Rather a shape of the foot inner part and of the foot outer part which is adapted to a foot shape should be regarded as particularly advantageous.

Before, during or after production of the tubular object, at least one heating element and also supply lines are applied on a flexible carrier element. The flexible carrier element with the heating element and the supply lines is applied subsequently in or on the tubular object. In addition, terminals for detachable mechanical and electrical connection of the sock to a voltage supply are fitted on the sock.

The tubular object with the terminals disposed thereon and the flexible carrier element with the heating element and the supply lines is subsequently turned over in such a manner that the foot inner part is disposed in the foot outer part and the leg inner part in the leg outer part. As a result, a sock is produced, the toe region remaining still open. This is subsequently closed, for example by linking.

When closing the foot region, the foot inner part and the foot outer part are preferably connected to each other, twisting of the inner sock relative to the outer sock being prevented by these connections, together with the connection via the cuff.

### BRIEF DESCRIPTION OF THE DRAWINGS

Embodiments of the invention are explained subsequently in more detail with reference to the Figures. There are shown:

FIG. 1 a schematic representation of an advantageous embodiment of an electrically heatable sock,

FIG. 2 a representation of the contacting and attachment of the battery pack,

FIG. 3 a perspective view of the battery pack diagonally from the front,

FIG. 4 a perspective view of the battery pack diagonally from the rear,

FIG. 5 a representation of a sock blank after a first method step of an advantageous embodiment of the method according to the invention,

FIG. 6 a plan view on a background material with heating element and supply lines applied thereon and

FIG. 7 a view diagonally from above on an alternative embodiment of a battery pack.

### DETAILED DESCRIPTION OF THE INVENTION

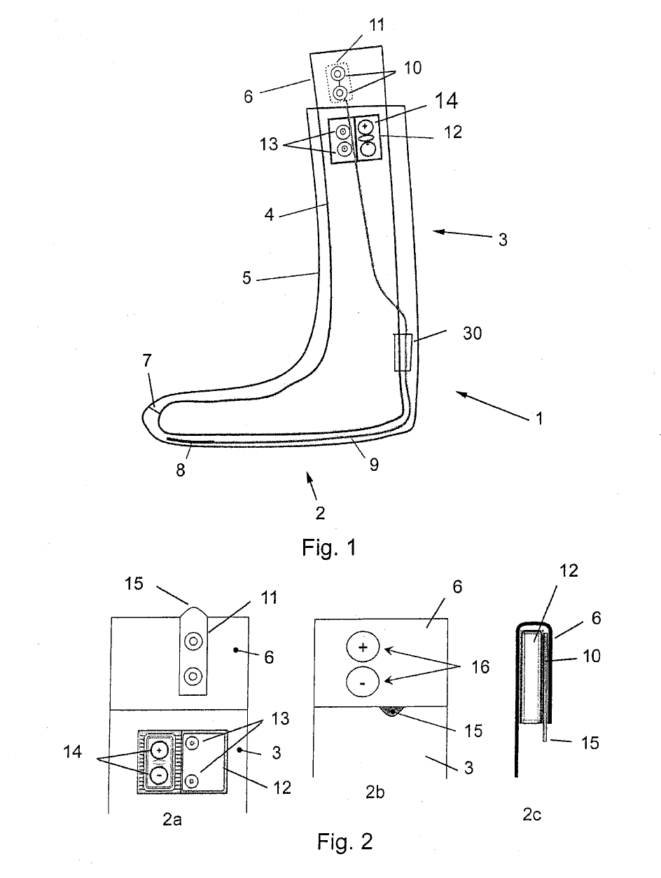

In FIG. 1, an electrically heatable sock 1 which has a foot region 2 and a leg region 3 is represented. The sock 1 comprises an inner sock 4 and an outer sock 5, inner and outer sock 4, 5 merging at their upper edge into a cuff 6 and being connected by this to each other. In the region of the toes, a further connection 7 between inner sock 4 and outer sock 5 is provided, by means of which twisting of the inner sock 4 relative to the outer sock 5 is reliably prevented. Likewise, a heating element 8 which is connected to push-button contacts 10 via supply lines 9 is disposed in the region of the toes. The supply lines extend, starting from the heating element 8, firstly below the foot in a straight line to the heel and are fixed there. Starting from the heel, the supply lines pass through an Achilles tendon protector 30 and are guided above said protector laterally from the lower leg to the terminals which are configured as push-button contacts 10.

The push-button contacts 10 are disposed in the region of the cuff 6 and are attached to this by means of a sewn-on textile carrier 11. A battery pack 12 is represented below the cuff. The battery pack is hereby shown in the position in which it is fixed when the cuff 6 is folded over. The battery pack 12 has push-button contacts 13 which correspond to the push-button contacts 10 on the cuff 6 and are designed for the purpose of entering into a form-fit connection with these. In addition, the battery pack 12 comprises control elements 14 which are connected to a control module integrated in the battery pack 12 for regulation of the heating power.

The principle of the attachment of the battery pack is represented in detail in FIG. 2. FIG. 2a represents the upper end of the electrically heatable sock 1 when the band or cuff is folded back. The battery pack is illustrated just below the cuff 6, normally said battery pack not being fixed when the cuff 6 is folded back and hence being illustrated for clarification. If desired, the underside of the battery pack can however be provided with a Velcro fastener which adheres to the sock.

In FIG. 2b, the upper end of the sock 1 with the folded-over cuff is represented. A tab 15 which, as can be detected in FIG. 2a, is designed in one piece with the carrier 11 protrudes beyond the downwardly pointing end of the cuff 6. In the folded-over state of the cuff 6, the push-button contacts 10 on the carrier 11 are connected to the push-button contacts 13 of the battery pack 12. As a result, fixing of the battery pack 12 is achieved. A further stabilisation of the position of the battery pack 12 is produced by a circumference of the cuff 6 being enlarged in the folded-over state as a result of the battery pack 12 disposed thereunder relative to a circumference in the non-folded-over state, the cuff counteracting stretching caused as a result with a force, as a result of which the battery pack 12 is pressed in the direction of the leg.

In the folded-over state of the cuff 6, markings 16 which are applied on an inside of the cuff 6 are visible from outside and hence for a user. These markings are situated on the input elements 14 which can be designed for example as push-contacts or key buttons. By means of the markings 16, the positions of the input elements 14 are characterised in a visible manner for a user, as a result of which reliable actuation of the input elements 14 of the battery pack 12 which is concealed per se becomes possible without folding back the cuff 6 in advance (this is often also termed collar).

In FIG. 2c, the upper end of the electrically heatable sock 1 is represented in section, the mode of operation of the tab 15 being able to be detected particularly well in this view. This is available because of the forwards offset arrangement produced by the battery pack 12 and can be gripped easily by a user. As a result, folding over of the collar 6, for example for changing or charging the battery pack 12 is significantly simplified.

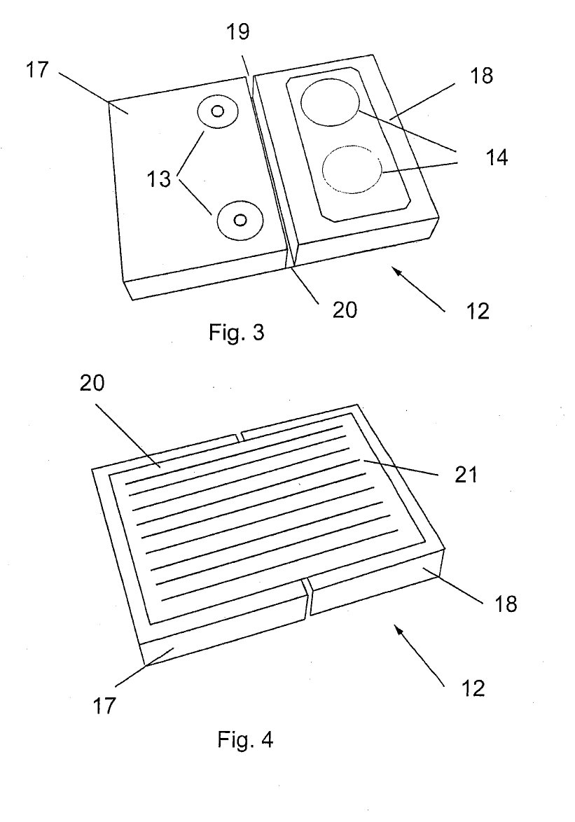

The battery pack 12 is represented in more detail in a perspective view diagonally from above in FIG. 3. The battery pack 12 is designed in two parts with a first part 17 and a second part 18. On the first part 17, the push-button contacts 13 are disposed, whereas the second part 18 has the input elements 14. Between both parts 17, 18 there is a gap 19, a connection of both parts being ensured via a flexible layer 20. Both the outer covering of the two parts 17, 18 and the layer 20 can consist of silicone or another similarly flexible plastic material. By means of the gap 19 between both parts 17, 18, the layer 20 can serve as a film hinge, as a result of which tilting of both parts 17, 18 relative to each other is made possible. This tilting enables improved adaptation to a shape of the leg of a user of the electrically heatable sock 1 and hence leads to a significant increase in wearing comfort.

In FIG. 4, the battery pack 12 is represented in a perspective view on the rear side, it being able to be detected in this view that the rear-side of the layer 20 has grooves 21. These serve to increase the adhesive friction between the battery pack 21 and the leg region 3 of the sock 1 and hence further reduce the risk of sliding of the battery pack 12.

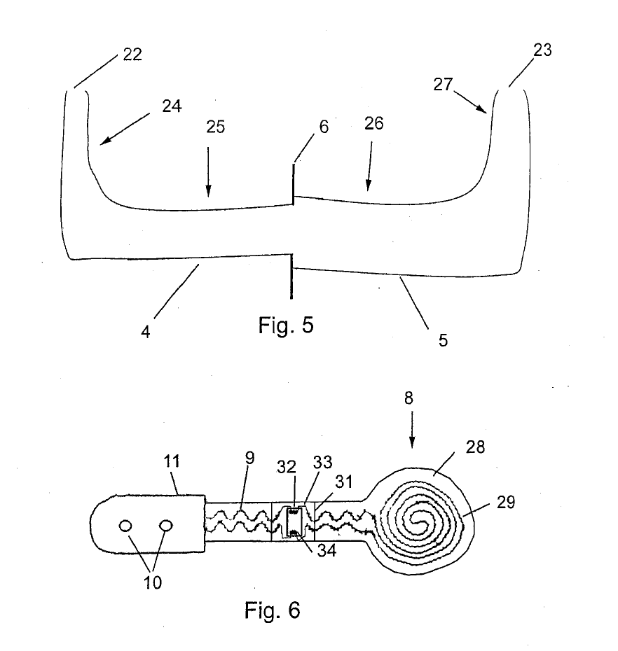

In FIG. 5, a blank of an electrically heatable sock after a first method step of a method for producing an electrically heatable sock is represented. The blank has an essentially tubular configuration and has an inner foot region 24, an inner leg region 25, a cuff 6, an outer leg region 26 and an outer foot region 27. The different regions are produced in the mentioned sequence or precisely the reverse. Production is begun at one end of the tubularly configured blank and this is then manufactured continuously in one direction. The inner sock 4 consisting of inner foot- and inner leg region 24, 25 and also the outer sock 5 consisting of outer foot-27 and outer leg region 26 are designed respectively corresponding to a foot shape. Both inner sock 4 and outer sock 5 at this point in the method, have an opening 22, 23 in the region of the toes.

In FIG. 6, a heating element 8 applied on a background material 28 is represented. The heating element 8 has a heating wire 29 or a heating flex which extends in a spiral shape. A heating flex is hereby preferred because of its flexibility. The heating wire 29 or the heating flex is surrounded by a flexible plastic material, for example PVC, and is hence insulated. In the illustrated example, the heating wire 29 is configured as a double spiral, i.e. the heating wire extends, starting from one end, as a spiral inwardly and then extends further in a spiral back outwards to the other end. The heating wire 29 could however also be designed as a simple spiral which then has a twin-wire configuration. Therefore, a cable of a heating wire which runs back and forth can be disposed in a common casing. Of course, also other components for the heating element, such as strip conductors or other resistance surfaces, can also be used.

The ends of the heating wire 29 are connected to supply lines 9 which have an undulating configuration. The connection is disposed on a reinforcing element 32. For connection, ends 33 of the heating wire 29 or of the supply lines 9 were soldered onto contact regions 34 of the reinforcing element 32. The ends 33 are hereby guided to the contact region 34 such that they extend laterally to a longitudinal direction of the sock, i.e. in the direction of a bending axis produced by a rolling movement when walking. As a result, the ends are rotated about their axis instead of being bent during a rolling movement produced during walking. This significantly reduces the risk of failure by detachment of the connection.

The reinforcing element 32 is covered with a textile 31 for further stabilisation. Before application of the textile 31, an embedding material, not represented, for example a silicone, was applied on the reinforcing element. The embedding material covers the connection and in addition stabilises the latter as a result. In addition, the reinforcing element and the textile with the embedding material are completely drawn together, as a result of which particularly good adaptation of the material properties to the embedding material results.

In total, a flexible laminate is obtained such that the connection is relieved of stress and tension and also bending forces are diverted away from it.

The undulating design of the supply lines 9 (a meandering or zigzag design of the supply lines is similarly possible) leads to the fact that stretching of the supply lines 9 in their longitudinal direction is possible with a slight force and without damaging the supply lines 9. The carrier 11 with the push-button contacts 10 abuts against the background material 28 with the heating element 8 and the supply lines 30. The represented background material with the heating element 8 and the supply lines 9 is manufactured by sewing the heating wire 29 and the supply lines 9 onto the background material 28. Subsequently, the lower material 28 with the lines is introduced through the opening 22 into the inner sock 4 and sewed together with the latter. Subsequently, the inner sock 4 is turned over so that it is disposed in the outer sock 5, the lower material 28 sewn onto the inner sock 4 being positioned between inner sock 4 and outer sock 5. Subsequently, the openings 22, 23 are closed. This is possible for example by linking, the inner sock 4 being connected at the same time to the outer sock 5 in the region of the toes.

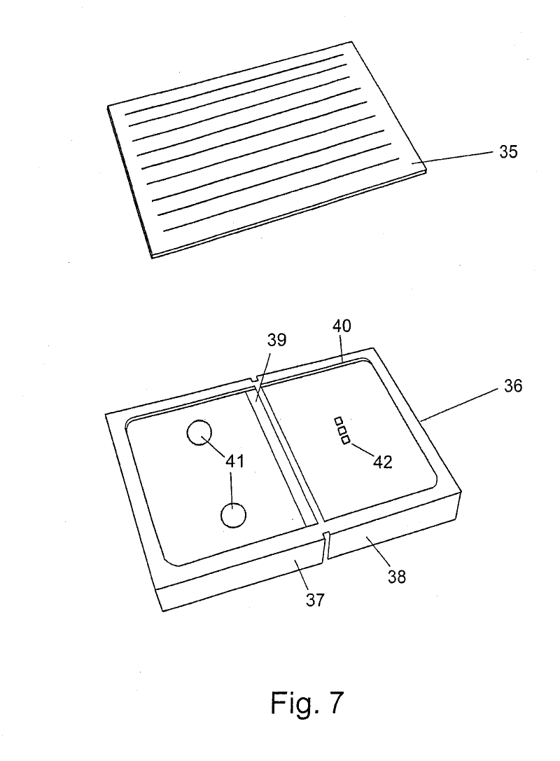

In FIG. 7, a housing of the battery pack according to FIG. 3 is represented, which housing consists of a housing element 36 and a cover element 35. The battery pack is manufactured by inserting the electronic components of the battery pack into the housing element 36 and subsequently closing the housing element 35 with the cover element 35 which corresponds to the connection element 20 according to FIG. 3. In the housing element 36, openings 41 for assembly of the push-button contacts 13 are provided and also openings 42 for display elements in order to display a set heating level.

In this embodiment, the housing element 36 has two regions 37, 38 which correspond to parts 17, 18 of the battery pack of FIG. 3. The housing element 36 has a central web 39 which connects the two regions 37, 38. In order to achieve as large as possible an inner volume of the housing element 36 which is available for incorporation of electronic components and at the same time as large a support surface as possible for the cover element 35, the housing element is equipped with a circumferential edge web 40 which is designed with an undercut, i.e. the region below the edge web 40 is available for electronic components.

The cover element 35 can have raised portions which correspond to the openings formed by the edge web 40 and the central web 39, i.e. which raised portions engage in the openings in the assembled state so that the received components can be covered without clearance. The cover element 35 and the housing part 36 which consist for example of silicone or a similar plastic material can be connected to each other, at least at the edge web 40 and the central web 39, for example by gluing or vulcanising.

What is claimed is:

1. An electrically heatable sock comprising a foot part and a leg part abutting thereon, at least one heating element being disposed on the foot part and being connected via supply lines to terminals for a voltage supply which has a battery, the terminals being disposed in the upper region of the leg part, wherein a cuff which can be folded over is disposed at the upper end of the leg part, the terminals being attached on the side of the cuff situated inside in the folded-over state and formed in order to fix the battery in the correct position in the folded-over state of the cuff and to retain it at least partially.

2. The sock according to claim 1, wherein the foot- and leg part underneath the cuff have an inner sock and an outer sock which are connected to each other.

3. The sock according to claim 1, wherein the terminals are configured as contacts which constitute a form-fit and/or frictional connection, in particular as push-button contacts.

4. The sock according to claim 1, wherein the terminals are configured as push-button contacts.

5. The sock according to claim 1, wherein the supply lines are disposed on a flexible carrier element and are configured to extend from a longitudinal direction of the sock.

6. The sock according to claim 1, wherein the supply lines are disposed on a flexible carrier element and are configured to extend in a meandering, zigzag and/or undulating shape from a longitudinal direction of the sock.

7. The sock according to claim 1, wherein the terminals are disposed on a flexible and/or textile carrier which is attached to the cuff.

8. The sock according to claim 1, wherein a tab which protrudes beyond the end of the cuff in the folded-over state is fitted on the cuff.

9. The sock according to claim 1, wherein the tab is configured in one piece with the carrier for the terminals.

10. The sock according to claim 1, wherein at least one marking for a control element for controlling the heating power is disposed on an inner side of the cuff.

11. The sock according to claim 1, wherein the inner- and the outer sock are connected to each other at at least two places.

12. The sock according to claim 1, wherein the inner- and the outer sock are connected to each other at at least two places, at least one place of which is situated in the leg part and one in the foot part.

13. The sock according to claim 1, wherein the at least one heating element and/or the carrier element is disposed with supply lines between inner and outer sock and is connected at least to the inner sock preferably by sewing.

14. A sock heating arrangement comprising a heatable sock according to claim 1 and also at least one battery pack, the battery pack having contacts which correspond to the terminals of the sock and the battery pack being attached detachably to the sock via the contacts.

15. The sock heating arrangement according to claim 14, wherein the battery pack includes a control unit for controlling the heating power, the control unit having a receiver for actuation via a remote control or an input element for setting a desired heating power.

16. The sock heating arrangement according to claim 15, wherein the input element is disposed on the same side of the battery pack as the contacts.

17. A method for producing a heatable sock, comprising the steps of:
production of a foot inner part, a leg inner part, a cuff, a leg outer part and a foot outer part in the indicated or reverse sequence as a one-piece tubular object with at least one open end;
application of a heating element and also supply lines on a flexible carrier element;
application of the flexible carrier element with the heating element and the supply lines in or on the tubular object;
fitting of terminals on the cuff for detachable mechanical and electrical connection of the sock to a voltage supply;
partial turning over of the tubular object so that a sock is formed, the foot inner part with the foot outer part forming a foot part of the sock and the leg inner part with the leg outer part and the cuff forming a leg part of the sock; and
closing of the at least one open end.

18. The method according to claim 17, wherein the foot inner part and the foot outer part are connected to each other by closing the at least one open end, for example linking.
